(19) United States
(12) Patent Application Publication
(10) Pub. No.: US 2025/0360516 A1
(43) Pub. Date: Nov. 27, 2025

(54) ELECTRIFICATION PART FOR ELECTRIC DUST COLLECTOR

(71) Applicant: Hanon Systems, Daejeon (KR)

(72) Inventor: Ji-Yong PARK, Daejeon (KR)

(73) Assignee: Hanon Systems, Daejeon (KR)

(21) Appl. No.: 19/179,930

(22) Filed: Apr. 15, 2025

(30) Foreign Application Priority Data
Apr. 22, 2024 (KR) 10-2024-0053388

(51) Int. Cl. B03C 3/45; B03C 3/82

(52) U.S. Cl. CPC B03C 3/45; B03C 3/82

(57) ABSTRACT

The present invention relates to an electrification part for an electric dust collector, the electrification part including a casing, a counter electrode having two opposite ends coupled to the casing, a first support part configured to cover and block one end of the counter electrode, a second support part configured to cover and block the other end of the counter electrode, and a discharge electrode disposed to be spaced apart from the counter electrode and coupled to the first support part and the second support part, in which one side of the discharge electrode is physically separated from one end of the counter electrode and the other side of the discharge electrode is physically separated from the other end of the counter electrode.

### CROSS REFERENCE TO RELATED APPLICATION

The present application claims priority to Korean Patent Application No. 10-2024-0053388, filed on Apr. 22, 2024, the entire contents of which are incorporated herein for all purposes by this reference.

### BACKGROUND OF THE INVENTION

### Field of the Invention

The present invention relates to an electrification part for an electric c dust collector, and more particularly, to an electrification part that electrifies dust particles so that the dust particles have particular charges by means of a corona discharge phenomenon.

### Description of the Related Art

FIG. 1 is a conceptual view illustrating an electric dust collector in the related art, and FIG. 2 is a perspective view illustrating an electrification part for an electric dust collector in the related art.

As illustrated, the electric dust collector includes an electrification part 10 configured to electrify dust particles so that the dust particles have particular charges by means of a corona discharge phenomenon, and a dust-collecting part 20 configured to collect dust particles electrified by the electrification part.

For example, the electrification part 10 may include a casing 11 having a frame shape and having a central portion penetratively formed in a direction 14 in which dust-containing air is introduced, a plurality of counter electrodes 12 each having a plate shape and two opposite ends coupled to the casing 11, the plurality of counter electrodes 12 being disposed to be spaced apart from one another, and discharge electrodes 13 each having a wire shape and having two opposite sides coupled to the casing 11, the discharge electrodes 13 being disposed between the plurality of counter electrodes 12, spaced apart from one another, and configured to receive a high voltage. Therefore, when a relatively high voltage is applied to the discharge electrodes 13 and a reference voltage (or a ground voltage) is applied to the counter electrodes 12, and an electric field is formed between the discharge electrodes 13 and the counter electrodes 12, such that the dust-containing air may be electrified while passing between the discharge electrodes 13 and the counter electrodes 12 so that dust particles have particular charges. Further, the dust-collecting part 20 may collect the dust particles, which are electrified while passing through the electrification part 10, by means of an electrical attractive force by using opposite charge characteristics.

In this case, at the initial time of the operation of the electric dust collector, a corona discharge, in which insulation in the air between the discharge electrode and the counter electrode of the electrification part is destroyed and ions are released, occurs, such that the function of electrifying dust particles normally is implemented.

However, dust accumulates in a casing of the electrification part over time, and the dust accumulated in the casing serves as a conductor, such that a physical, electrical conduction route is formed between the discharge electrode and the counter electrode. For this reason, there is a problem in that an abnormal discharge occurs between the discharge electrode and the counter electrode through the surface of the casing on which the dust is accumulated, which may degrade the performance of the electrification part.

### DOCUMENT OF RELATED ART

### Patent Document

KR 10-2634227 B1 (registered on Feb. 1, 2024) “ELECTRIFICATION PART AND ELECTRIC DUCT-COLLECTING DEVICE INCLUDING THE SAME”

### SUMMARY OF THE INVENTION

The present invention is proposed to solve these problems and aims to provide an electrification part for an electric dust collector, in which a discharge electrode and a counter electrode are physically blocked from each other at a portion where the discharge electrode and the counter electrode are coupled to the casing, thereby preventing an abnormal discharge phenomenon between the discharge electrode and the counter electrode.

In order to achieve the above-mentioned object, the present invention provides an electrification part for an electric dust collector, the electrification part including: a casing having therein openings formed through two opposite surfaces thereof; a counter electrode having two opposite ends coupled to the casing; a first support part coupled to one side of the casing and configured to cover and block one end of the counter electrode; a second support part coupled to the other side of the casing and configured to cover and block the other end of the counter electrode; and a discharge electrode disposed to be spaced apart from the counter electrode and having one side coupled to the first support part and the other side coupled to the second support part, in which one side of the discharge electrode is physically separated from one end of the counter electrode and the other side of the discharge electrode is physically separated from the other end of the counter electrode.

In addition, a through-hole formed through two opposite surfaces of the casing may be formed in the casing, fastening holes corresponding to the through-hole may be formed in the first support part and second support part, a separate fastening member may pass through the through-hole from the outside of the casing, one end of the fastening member may be inserted and coupled into the fastening holes, the other end of the fastening member may be caught by the casing, and the first support part and the second support part may be fixed to the casing.

In addition, the fastening hole of the casing may be formed in a shape in which a side opposite to a side at which the fastening member is inserted is blocked.

In addition, the fastening member may be a bolt, and an internal thread may be formed on the fastening hole of the casing and coupled to the fastening member.

In addition, a seating groove may be formed in the casing, a protruding portion may be formed on the first support part, and the protruding portion may be inserted and coupled into the seating groove.

In addition, the electrification part may further include: a first cover coupled to the first support part and configured to cover and block one side of the counter electrode; and a second cover coupled to the second support part and configured to cover and block the other side of the counter electrode.

In addition, one side of the discharge electrode may be configured such that the remaining surface, except for a surface directed toward the other side, is blocked by the first support part and the first cover.

In addition, the other side of the discharge electrode may be configured such that the remaining surface, except for a surface directed toward one side, is blocked by the second support part and the second cover.

In addition, fixing grooves may be formed at two opposite sides of the casing, and one end and the other end of the counter electrode may be inserted and coupled into the fixing grooves.

In addition, a fixing groove, into which one end of the counter electrode is inserted, may be formed in the first support part, and a fixing groove, into which the other end of the counter electrode is inserted, may be formed in the second support part.

In addition, a fixing portion, to which one side of the discharge electrode is coupled, may be formed on the first support part, and a fixing portion, to which the other side of the discharge electrode is coupled, may be formed on the second support part.

### BRIEF DESCRIPTION OF THE DRAWINGS

FIG. 1 is a conceptual view illustrating an electric dust collector in the related art.

FIG. 2 is a perspective view illustrating an electrification part for an electric dust collector in the related art.

FIGS. 3 and 4 are assembled perspective views illustrating an electrification part for an electric dust collector according to an embodiment of the present invention.

FIGS. 5 and 6 are perspective views illustrating a casing and a counter electrode of the electrification part for an electric dust collector according to the embodiment of the present invention.

FIG. 7 is a perspective view illustrating a first support part, a second support part, a first cover, and a second cover of the electrification part for an electric dust collector according to the embodiment of the present invention.

FIG. 8 is a perspective view illustrating a discharge electrode of the electrification part for an electric dust collector according to the embodiment of the present invention.

FIG. 9 is a partial perspective view illustrating the casing of the electrification part for an electric dust collector according to the embodiment of the present invention.

FIG. 10 is a perspective view illustrating a state in which the counter electrode is assembled in the casing in FIG. 9.

FIG. 11 is a perspective view illustrating a state in which the first support part and the discharge electrode in FIG. 10 are assembled.

FIG. 12 is a perspective view illustrating a state in which the first cover in FIG. 11 is assembled.

FIG. 13 is a perspective view illustrating a cross-section made by cutting a part of the casing of the electrification part for an electric dust collector according to the embodiment of the present invention.

FIG. 14 is a cross-sectional view illustrating a portion where the casing and the first support part of the electrification part for an electric dust collector according to the embodiment of the present invention are coupled.

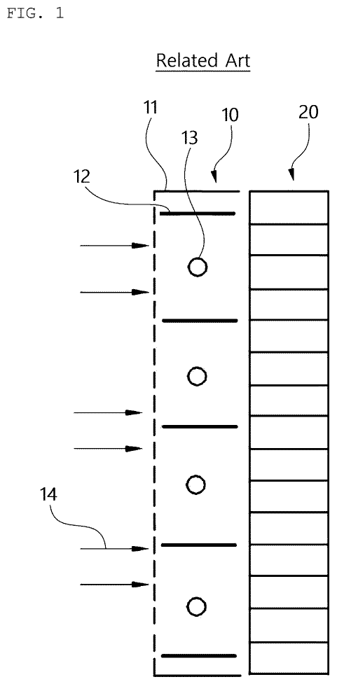

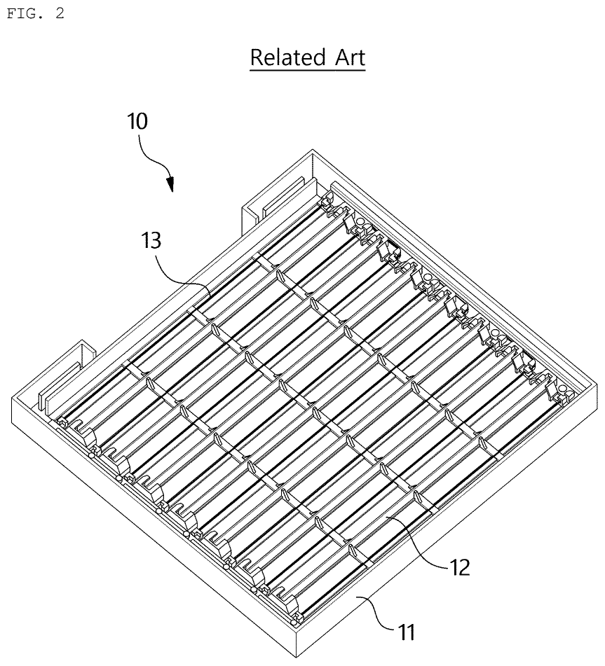

### DETAILED DESCRIPTION OF THE INVENTION

Hereinafter, an electrification part for an electric dust collector of the present invention configured as described above will be described in detail with reference to the accompanying drawings.

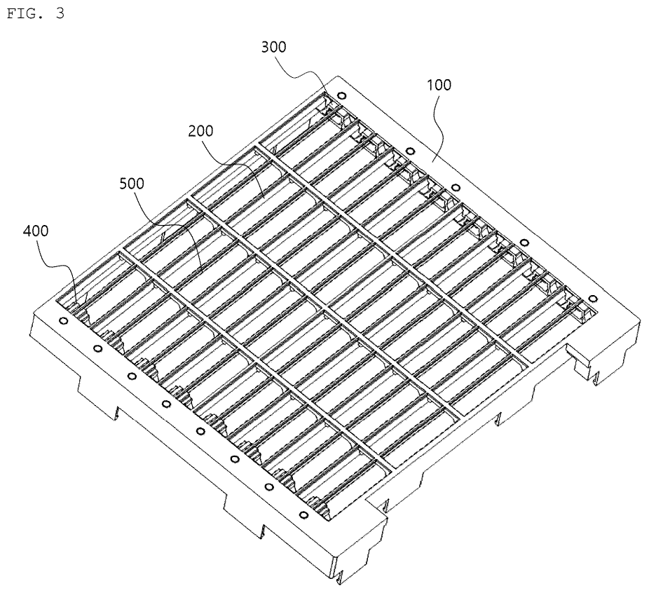

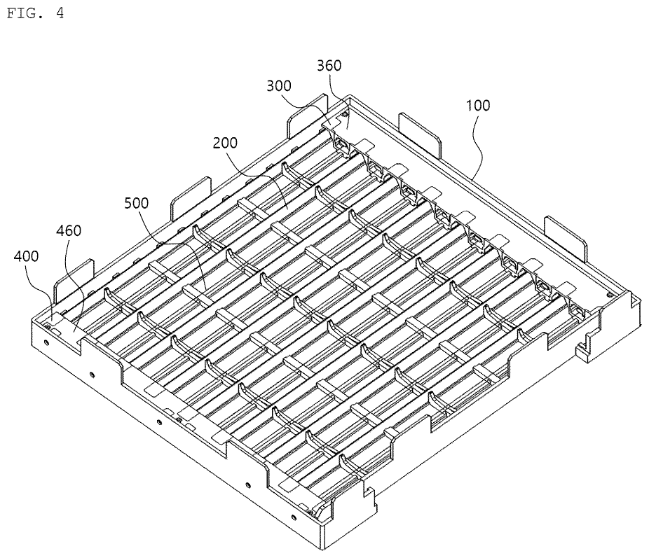

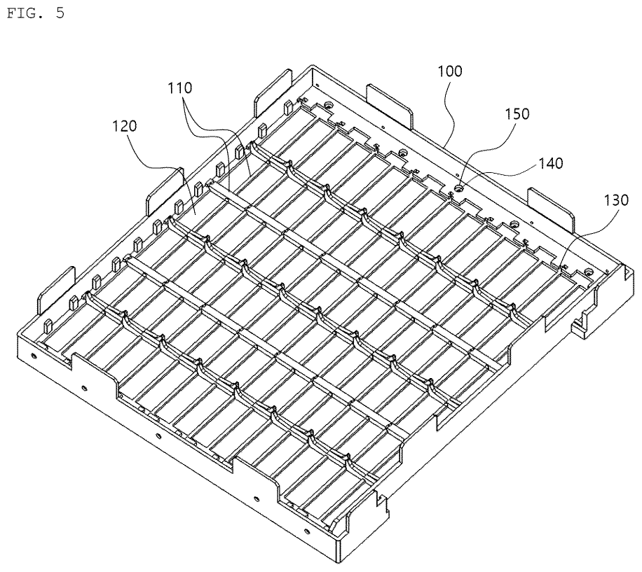

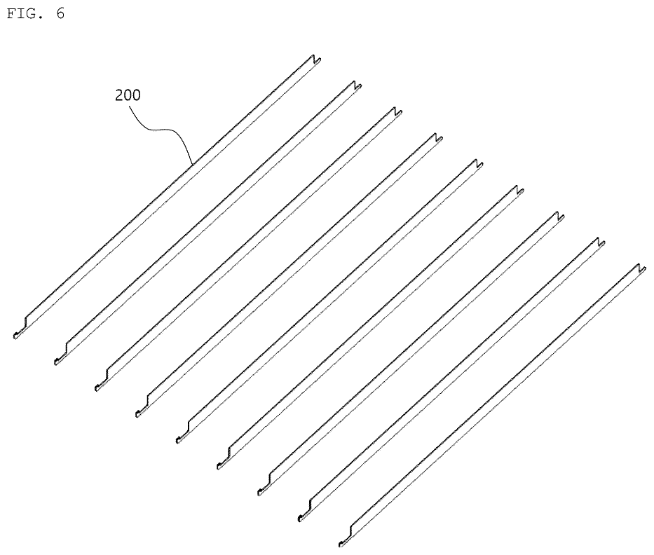

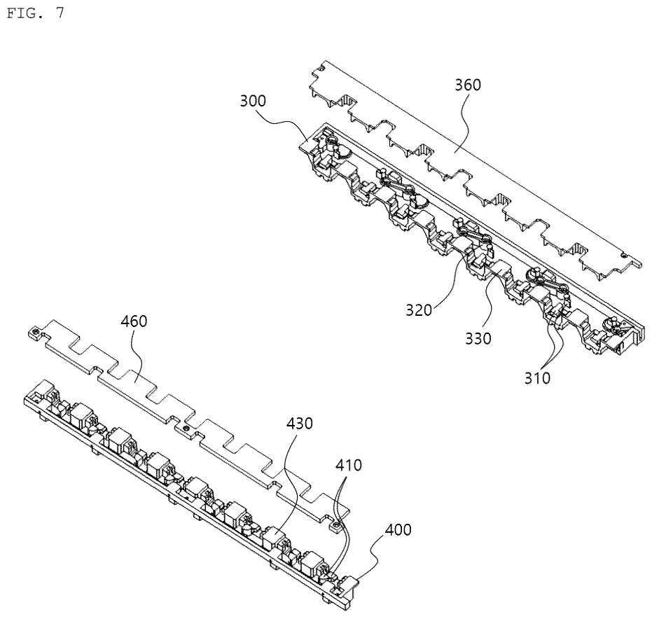

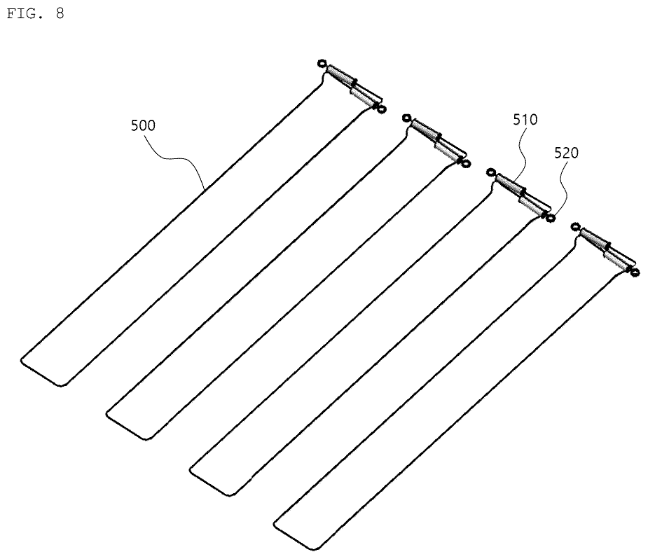

FIGS. 3 and 4 are assembled perspective views illustrating an electrification part for an electric dust collector according to an embodiment of the present invention, and FIGS. 5 to 8 are perspective views illustrating a casing, a counter electrode, a first support part, a second support part, a first cover, a second cover, and a discharge electrode of the electrification part for an electric dust collector according to the embodiment of the present invention.

As illustrated, the electrification part for an electric dust collector according to the embodiment of the present invention may include a casing 100, counter electrodes 200, a first support part 300, a second support part 400, and discharge electrodes 500 and further include a first cover 360 and a second cover 460.

For example, the casing 100 may be formed in a shape in which ribs 110 are connected inside a quadrangular frame. Openings 120 may be formed through two opposite surfaces of the casing and disposed between the ribs 110, and air may pass through the openings. Further, fixing grooves 130 may be formed at one side of the casing 100, and one end of the counter electrode 200 may be inserted and coupled into each of the fixing grooves 130. The fixing grooves 130 may be formed at the other side of the casing 100, and the other end of the counter electrode 200 may be inserted and coupled into each of the fixing grooves 130. In addition, the casing 100 may be made of a plastic material or the like with electrical insulation.

For example, the counter electrode 200 may be formed in a plate shape in which a length is larger than a width, and the counter electrode 200 may be made of a metallic material or the like that transmits electricity. The counter electrodes 200 may be provided as a plurality of counter electrodes 200, and the plurality of counter electrodes 200 may be disposed in parallel with one another and spaced apart from one another. Further, although not illustrated, an electrode lead may be connected to the other end of each of the plurality of counter electrodes 200, a reference voltage or a ground voltage may be applied to each of the plurality of counter electrodes 200 through the electrode lead. One end of the counter electrode 200 may be coupled to one side of the casing 100, and the other end of the counter electrode 200 may be coupled to the other side of the casing 100.

The first support part 300 may be coupled to one side of the casing 100, and the first support part 300 may cover and block one end of each of the plurality of counter electrodes 200. Fixing portions 310 may protrude from the first support part 300, and one side of the discharge electrode 500 may be fixed by being caught by the fixing portion 310. Further, counter electrode accommodation portions 330 may be formed on the first support part 300 and disposed at positions corresponding to the counter electrodes 200. Terminal accommodation portions 320 may be formed on the first support part 300, and terminals 520 and connection terminals 530 connected to the discharge electrodes 500 may be inserted into the terminal accommodation portions 320. In addition, fixing grooves 350 may be formed in the first support part 300, and one end of the counter electrode 200 may be inserted into each of the fixing grooves 350. In addition, the first cover 360 may be coupled to the first support part 300, and the first cover 360 may cover and block an opened portion of the first support part 300.

The second support part 400 may be coupled to the other side of the casing 100, and the second support part 400 may cover and block the other end of each of the plurality of counter electrodes 200. Fixing portions 410 may protrude from the second support part 400, and the other side of the discharge electrode 500 may be fixed by being caught by the fixing portion 410. Further, counter electrode accommodation portions 430 may be formed on the second support part 400 and disposed at positions corresponding to the counter electrodes 200. Fixing grooves may be formed in the second support part 400, and one end of the counter electrode 200 is inserted into each of the fixing grooves. In addition, the second cover 460 may be coupled to the second support part 400.

For example, the discharge electrode 500 may have a wire shape, and the discharge electrode 500 may be made of a metallic material or the like that transmits electricity. One side of the discharge electrode 500 may be coupled to the first support part 300, and the other side of the discharge electrode 500 may be coupled to the second support part 400. Further, the discharge electrodes 500 may be provided as a plurality of discharge electrodes 500, and the plurality of discharge electrodes 500 may be disposed in parallel with one another and spaced apart from one another. The discharge electrode 500 may be disposed between the adjacent counter electrodes 200, and the discharge electrode 500 may be disposed to be spaced apart from the counter electrode 200. In addition, a spring 510 may be connected to one end of each of the two adjacent discharge electrodes 500, and the terminal 520 may be connected to an end of the spring. The terminal 520 may be inserted into the terminal accommodation portion 320 formed on the first support part 300. The connection terminal 530 may be inserted into the terminal accommodation portion 320, and the connection terminal 530 and the terminal 520 may be connected by fastening a separate fixing member to the terminal accommodation portion 320. In addition, the other ends of the two adjacent discharge electrodes 500 may be shaped to be connected into one piece. That is, a middle portion of one discharge electrode 500 having one wire shape is caught by the fixing portion 410 of the second support part 400, and one side of one discharge electrode 500 is pulled, such that the discharge electrode 500 has an approximately “U” shape. Further, one side of the discharge electrode 500 is caught by the fixing portion 410 of the first support part 300 and pulled, and the terminal 520 is inserted into the terminal accommodation portion 420, such that the discharge electrode 500 may be fixed. Therefore, in a state in which the discharge electrode 500 having a wire shape maintains appropriate tension, the discharge electrode 500 may be coupled to the first support part 300 and the second support part 400. In addition, an electric wire may be connected to the terminal 520 of the discharge electrode 500 disposed at the outermost side, such that a high voltage may be applied to the discharge electrode 500.

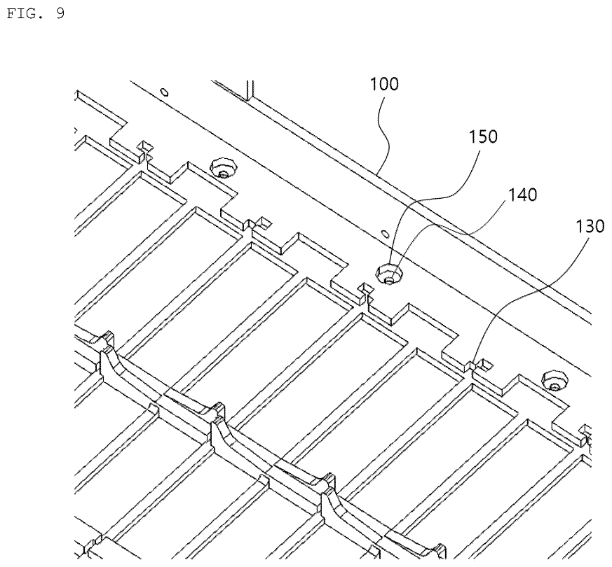

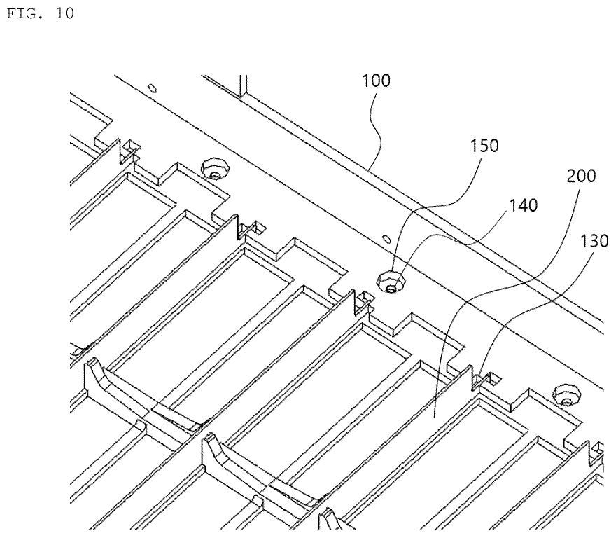

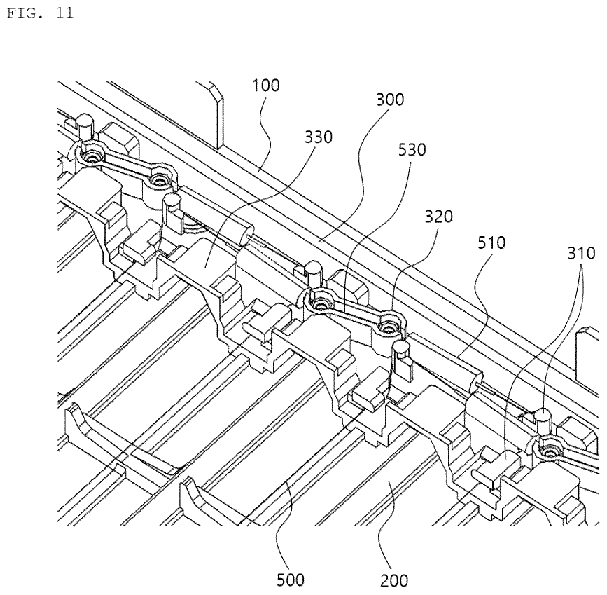

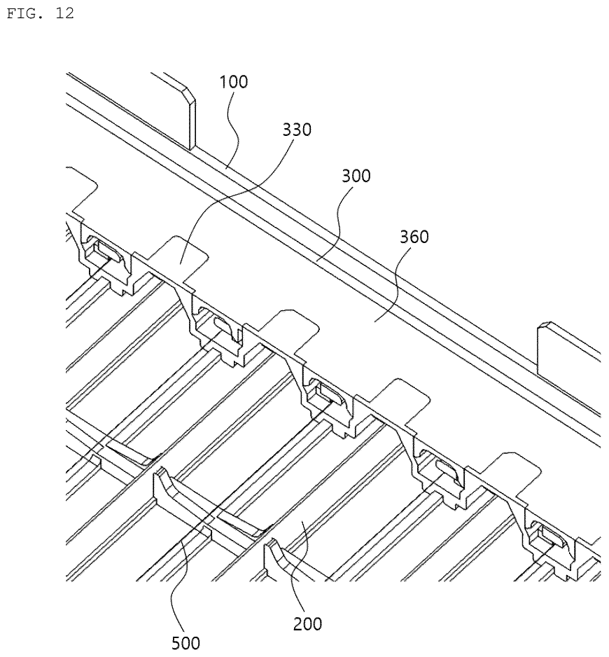

FIGS. 9 to 12 are partial perspective views illustrating a process of assembling the electrification part for an electric dust collector according to the embodiment of the present invention.

As illustrated, in a state in which the casing 100 is inverted, the plurality of counter electrodes 200 are coupled to the inside of the casing 100, and then the first support part 300 and the second support part 400 are coupled to the casing 100. Next, the plurality of discharge electrodes 500 are coupled to the first support part 300 and the second support part 400, the connection terminals 530 are coupled to the first support part 300, and then the first cover 360 and the second cover 460 are assembled, such that the electrification part of the present invention may be formed.

In this case, one side of the discharge electrode 500 may be physically separated from one end of the counter electrode 200 with the first support part 300 interposed therebetween, and the other side of the discharge electrode 500 may be physically separated from the other side of the counter electrode 200 with the second support part 400 interposed therebetween. For example, as illustrated, one side of the discharge electrode 500 may be formed in a shape in which the remaining surfaces, except for a surface directed toward the other side, are blocked by the first support part 300 and the first cover 360. Further, the other side of the discharge electrode 500 may be formed in a shape in which the remaining surfaces, except for a surface directed toward one side, are blocked by the second support part 400 and the second cover 460. That is, the assembly of the first support part 300 and the first cover 360 is formed in a shape in which only a region through which the discharge electrode 500 is withdrawn is opened. Likewise, the assembly of the second support part 400 and the fourth cover 460 may be formed in a shape in which only a region through which the discharge electrode 500 is withdrawn is opened.

Therefore, in the electrification part for an electric dust collector of the present invention, the discharge electrode and the counter electrode are physically separated and blocked from each other at the portion where the discharge electrode and the counter electrode are coupled to the casing, the first support part, and the second support part. Therefore, even though dust accumulates in the casing as the electrification part is used for a long period of time, an abnormal discharge phenomenon between the discharge electrode and the counter electrode may be prevented, thereby maintaining the performance of the electrification part.

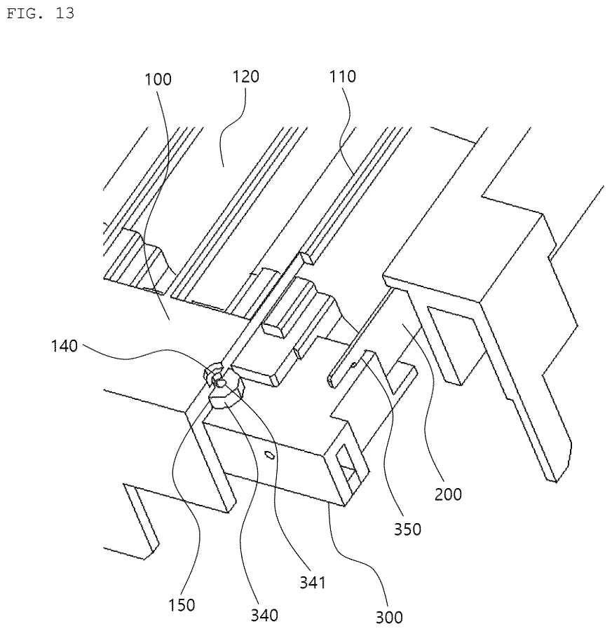

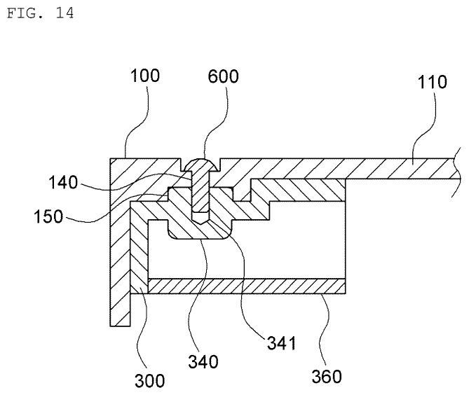

FIG. 13 is a perspective view illustrating a cross-section made by cutting a part of the casing of the electrification part for an electric dust collector according to the embodiment of the present invention, and FIG. 14 is a cross-sectional view illustrating a portion where the casing and the first support part of the electrification part for an electric dust collector according to the embodiment of the present invention are coupled.

As illustrated, through-holes 140 formed through two opposite surfaces of the casing 100 may be respectively formed at one side and the other side of the casing 100. Further, a fastening hole 341 corresponding to the through-hole 140 may be formed in the first support part 300, and an internal thread may be formed on the fastening hole 341. Therefore, a bolt, which is a separate fastening member 600, may pass through the through-hole 140 from the outside of the casing 100, one end of the fastening member 600 may be inserted and coupled into the fastening hole 341, and the other end of the fastening member 600 may be caught by the casing 100, such that the first support part 300 may be fixed to the casing 100. The second support part 400 may also be fixed to the casing 100 by the above-mentioned method. In this case, a portion where the fastening hole 341 is formed in the casing 100 may be formed in a shape in which a side opposite to a side at which the fastening member 600 is inserted is blocked. Therefore, the fastening member 600 may not be exposed to the discharge electrode 500, such that an abnormal discharge phenomenon may be prevented.

In addition, a seating groove 150 may be formed in the casing 100 and disposed at a position corresponding to the through-hole 140, and a protruding portion 340 may be formed on the first support part 300 and disposed at a position corresponding to the fastening hole 341, such that the protruding portion 340 may be inserted and coupled into the seating groove 150. The second support part 400 may also be coupled to the casing 100 by the above-mentioned method. Therefore, it is possible to remarkably reduce a likelihood that the fastening member 600 is electrically connected to the counter electrode 200 through a gap between the casing 100 and the first support 300, thereby preventing an abnormal discharge phenomenon.

In the electrification part for an electric dust collector of the present invention, the discharge electrode and the counter electrode are physically separated and blocked from each other at the portion where the discharge electrode and the counter electrode are coupled to the casing. Therefore, even though dust accumulates in the casing as the electrification part is used for a long period of time, an abnormal discharge phenomenon between the discharge electrode and the counter electrode may be prevented, thereby maintaining the performance of the electrification part.

The present invention is not limited to the above embodiments, and the scope of application is diverse. Of course, various modifications and implementations made by any person skilled in the art to which the present invention pertains without departing from the subject matter of the present invention claimed in the claims.

DESCRIPTION OF REFERENCE NUMERALS

| | |
|---|---|
| 100: Casing | 110: Rib |
| 120: Opening | 130: Fixing groove |
| 140: Through-hole | 150: Seating groove |
| 200: Counter electrode | 300: First support part |
| 310: Fixing portion | |
| 320: Terminal accommodation portion | |
| 330: Counter electrode accommodation portion | |
| 340: Protruding portion | |
| 341: Fastening hole | 350: Fixing groove |
| 360: First cover | |
| 400: Second support part | |
| 410: Fixing portion | |
| 430: Counter electrode accommodation portion | |
| 460: Second cover | 500: Discharge electrode |
| 510: Spring | 520: Terminal |
| 530: Connection terminal | 600: Fastening member |

What is claimed is:

1. An electrification part for an electric dust collector, the electrification part comprising:
a casing having therein openings formed through two opposite surfaces thereof;
a counter electrode having two opposite ends coupled to the casing;
a first support part coupled to one side of the casing and configured to cover and block one end of the counter electrode;
a second support part coupled to the other side of the casing and configured to cover and block the other end of the counter electrode; and
a discharge electrode disposed to be spaced apart from the counter electrode and having one side coupled to the first support part and the other side coupled to the second support part,
wherein one side of the discharge electrode is physically separated from one end of the counter electrode and the other side of the discharge electrode is physically separated from the other end of the counter electrode.

2. The electrification part of claim 1, wherein a through-hole formed through two opposite surfaces of the casing is formed in the casing, fastening holes corresponding to the through-hole are formed in the first support part and second support part, a separate fastening member passes through the through-hole from the outside of the casing, one end of the fastening member is inserted and coupled into the fastening holes, the other end of the fastening member is caught by the casing, and the first support part and the second support part are fixed to the casing.

3. The electrification part of claim 2, wherein the fastening hole of the casing is formed in a shape in which a side opposite to a side at which the fastening member is inserted is blocked.

4. The electrification part of claim 2, wherein the fastening member is a bolt, and an internal thread is formed on the fastening hole of the casing and coupled to the fastening member.

5. The electrification part of claim 2, wherein a seating groove is formed in the casing, a protruding portion is formed on the first support part, and the protruding portion is inserted and coupled into the seating groove.

6. The electrification part of claim 1, further comprising:
a first cover coupled to the first support part and configured to cover and block one side of the counter electrode; and
a second cover coupled to the second support part and configured to cover and block the other side of the counter electrode.

7. The electrification part of claim 6, wherein one side of the discharge electrode is configured such that the remaining surface, except for a surface directed toward the other side, is blocked by the first support part and the first cover.

8. The electrification part of claim 6, wherein the other side of the discharge electrode is configured such that the remaining surface, except for a surface directed toward one side, is blocked by the second support part and the second cover.

9. The electrification part of claim 1, wherein fixing grooves are formed at two opposite sides of the casing, and one end and the other end of the counter electrode are inserted and coupled into the fixing grooves.

10. The electrification part of claim 1, wherein a fixing groove, into which one end of the counter electrode is inserted, is formed in the first support part, and a fixing groove, into which the other end of the counter electrode is inserted, is formed in the second support part.

11. The electrification part of claim 1, wherein a fixing portion, to which one side of the discharge electrode is coupled, is formed on the first support part, and a fixing portion, to which the other side of the discharge electrode is coupled, is formed on the second support part.
